(19) United States
(12) Patent Application Publication
(10) Pub. No.: US 2008/0069677 A1
(43) Pub. Date: Mar. 20, 2008

(54) Transport object levitation unit, transport object levitation apparatus and stage apparatus

(75) Inventors: Shunichi Kawachi, Yokosuka-shi (JP); Masayuki Fujikawa, Yokosuka-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/896,408

(22) Filed: Aug. 31, 2007

Related U.S. Application Data
(63) Continuation-in-part of application No. PCT/JP2006/303719, filed on Feb. 28, 2006.

(30) Foreign Application Priority Data
Mar. 3, 2005 (JP) P2005-059319
May 11, 2005 (JP) P2005-138859

(51) Int. Cl. B65G 35/00

(52) U.S. Cl. 414/676

(57) ABSTRACT

A transport object levitation unit includes: a blow-out channel and a suction channel, and the blow-out channel has a portion the channel cross section area of which discontinuously changes.

### CROSS-REFERENCE TO RELATED APPLICATIONS

This is a Continuation-In-Part application of PCT International Application No. PCT/JP2006/303719 filed on Feb. 26, 2006 and published on Sep. 8, 2006 as WO 2006/093130 which claims priority of JP2005-059319 filed on Mar. 3, 2005 and JP2005-138859 filed on May 11, 2005. The entire disclosures of the prior applications are incorporated herein by reference.

### BACKGROUND OF THE INVENTION

1. Field of the Invention

The present invention relates to a transport object levitation unit and a transport object levitation apparatus for levitating transport objects such as glass substrates contactlessly, and to a stage apparatus equipped therewith.

2. Related Background of the Invention

Conventionally, there has been known a technique in which transport objects such as glass substrates are levitated contactlessly by air. There is disclosed a technique in which air is blown out from a bottom face of a moving table through a blow-out channel to levitate the table, while the air is sucked through a suction channel, thereby improving a plane movement rigidity (that is, holding rigidity).

Since, however, by merely blowing out air from the bottom face of the moving table, as well as sucking the air, a sufficient holding rigidity of a substrate cannot be obtained, at the time of processing while the substrate is being conveyed, the substrate is vibrated in a large amplitude, and thus the required accuracy of processing cannot sufficiently be satisfied.

### SUMMARY OF THE INVENTION

The present invention has been made in view of the above-mentioned situations, and improves a holding rigidity when transport objects are levitated.

According to the present invention, a transport object levitation unit is provided in the blow-out channel portions the channel cross section area of which discontinuously changes, and the pressure drop is made to occur in the air.

Accordingly, the holding rigidity of a substrate can be improved and the vibration can be reduced.

According to this transport object levitation unit, a pressure drop of air can be made to occur at the portion which channel cross section area discontinuously changes. As a result, a holding rigidity of a substrate can be improved.

Preferably, the blow-out channel includes a small channel and a large channel the channel cross section area of which is larger than that of the small channel. As a result, since the channel cross section area discontinuously changes at the boundary between the small channel and the large channel, the pressure drop of air can be made to occur at this portion.

Preferably, the blow-out channel is constructed of a plurality of the small channels and a plurality of the large channels being alternately disposed. As a result, due to that the small channels and the large channels are alternately disposed, the pressure drop can be sufficiently accumulated.

Preferably, the blow-out channel is extended in a direction along the one principal surface. As a result, while the pressure drop is being accumulated, the transport object levitation unit can be constructed to be thin.

Preferably, the blow-out channel includes a bend part that is bent substantially at a right angle, and the large channel is provided at the bend part. As a result, with the large channels and the small channels efficiently located in a limited space, the pressure drop can be accumulated.

Preferably, the suction channel is extended along a direction substantially orthogonal to the one principal surface, and the portion other than the suction channel is substantially occupied by the blow-out channel. As a result, the pressure drop can be sufficiently accumulated in a limited space.

Preferably, a plurality of inlets for introducing an air in the blow-out channel is provided on the other principal surface facing the one principal surface; and a plurality of the inlets is communicated with the blow-out channel at different positions. As a result, by selecting one inlet and closing the other inlet, the length of the blow-out channel can be adjusted, thus enabling to make fine adjustments of the pressure drop.

Preferably, at least one of the plurality of large channels is constructed to be cubic or cuboid at an inner wall surface thereof, and the small channel on an entry side of the large channel and the small channel on an exit side of the large channel are connected to a first and a second inner wall surfaces facing each other of the large channel respectively; and the small channel on the entry side of the large channel is connected to one corner portion of the first inner wall surface, and the small channel on the exit side of the large channel is connected to one corner portion of the second inner wall surface at a position most remote from the one corner portion to which the small channel on the entry side of the large channel is connected. As a result, the pressure drop can be accumulated.

Furthermore, preferably, at least one of the plurality of large channels is constructed to be cubic or cuboid at an inner wall surface thereof, and the small channel on an entry side of the large channel and the small channel on an exit side of the large channel are connected to a first and a second inner wall surfaces adjacent to each other of the large channel respectively; and one of the small channels on the entry side and the exit side of the large channel is connected to one corner portion of the first inner wall surface, and the other of the small channels different form the one of the small channels is connected to one corner portion on the second inner wall surface that forms one apex together with a corner portion positioned on a diagonal line of the one corner portion on the first inner wall surface. As a result, the pressure drop can be accumulated.

Moreover, preferably, at least one of the plurality of large channels is constructed to be cubic or cuboid at an inner wall surface thereof, and the small channel on an entry side of the large channel and the small channel on an exit side of the large channel are connected to a first and a second inner wall surfaces adjacent to each other of the large channel respectively; and one of the small channels on the entry side and the exit side of the large channel is connected to a central portion on the first inner wall surface, and the other of the small channels different form the one of the small channels is connected to a corner portion on the second inner wall surface in a position most remote from the connection position of the one small channel. As a result, the pressure drop can be accumulated.

Preferably, there are provided a plurality of the above-mentioned transport object levitation units, and a plurality of the transport object levitation units is laminated in a direction perpendicular to the one principal surface. As a result, a large pressure drop can be accumulated in a limited installation area.

The present invention is a transport object levitation apparatus comprising a plurality of the above-mentioned transport object levitation units, wherein a plurality of the transport object levitation units is disposed two-dimensionally in a direction along the one principal surface.

In this transport object levitation apparatus, since the blow-out ports in communication with the blow-out channel, and the suction ports in communication with the suction channel are located two-dimensionally on one principal surface side, a transport object that extends in a direction along the one principal surface can be levitated with a high holding rigidity.

Preferably, a transport object levitation apparatus comprises a platen including a plurality of through-holes; and the platen is placed on the one principal surface of a plurality of the transport object levitation units disposed two-dimensionally, and a plurality of the through-holes is communicated air-tightly with the blow-out port and the suction port. As a result, due to that a principal surface of the platen on the side different from the side facing the transport object levitation unit can be a reference surface, the flatness of the face at which the air is blown out and sucked can be made higher.

The present invention is a stage apparatus comprising: the above-mentioned transport object levitation apparatus; and a transport apparatus configured to grip the transport object and cause it to pass over the transport object levitation apparatus.

According to this stage apparatus, the transport object can be gripped and conveyed by means of the transport apparatus. In particular, since when causing the transport object to pass over the transport object levitation apparatus, the transport object can be levitated with a sufficient holding rigidity, vibration can be sufficiently reduced.

The present invention will be appreciated further sufficiently from the following detailed description and the accompanying drawings. They are illustrative only and are not intended to limit the scope of the invention in any way.

According to the present invention, a holding rigidity when a transport object is levitated can be improved.

### BRIEF DESCRIPTION OF THE DRAWINGS

FIG. 1 is a perspective view illustrating a construction of a substrate inspection system according to an exemplary embodiment.

FIG. 2 is a plan view illustrating the construction of the substrate inspection system according to this embodiment (gantry is indicated by alternate long and short dashed lines).

FIG. 3 is a partially enlarged portion illustrating a construction of a transport apparatus.

FIG. 4 is a view illustrating a construction of a substrate levitation unit.

FIG. 5 is a view illustrating a state in which as to a plurality of holes of a platen the substrate levitation apparatus includes, through-holes for suction (indicated by open circles) and through-holes for blow-out (indicated by filled circles) are aligned two-dimensionally.

FIG. 6 is a sectional view illustrating a layout relation between the platen and the substrate levitation unit of the substrate levitation apparatus.

FIG. 7 is a view illustrating a variation of the substrate levitation unit.

FIG. 8 is a view illustrating another variation of the substrate levitation unit.

FIG. 9 is a perspective view extracting and illustrating only a blow-out channel and a suction channel as another variation of the substrate levitation unit.

FIG. 10 includes a plan view and a side view extracting and illustrating only the blow-out channel and the suction channel, and views indicated by arrows along the lines A-A to E-E in the variation shown in FIG. 9.

FIG. 11 is a perspective view illustrating one connection form between a large channel and a small channel.

FIG. 12 is a perspective view illustrating another connection form between the large channel and the small cannel.

FIG. 13 is a perspective view illustrating another connection form between the large channel and the small channel.

FIG. 14 is a perspective view illustrating a connection form as a comparative example between the large channel and the small channel.

### DETAILED DESCRIPTION OF THE PREFERRED EMBODIMENTS

Hereinafter, an exemplary embodiment according to the present invention will be described referring to the accompanying drawings. Incidentally, like reference numerals refer to the same elements in descriptions of the drawings, and duplicated descriptions will be omitted.

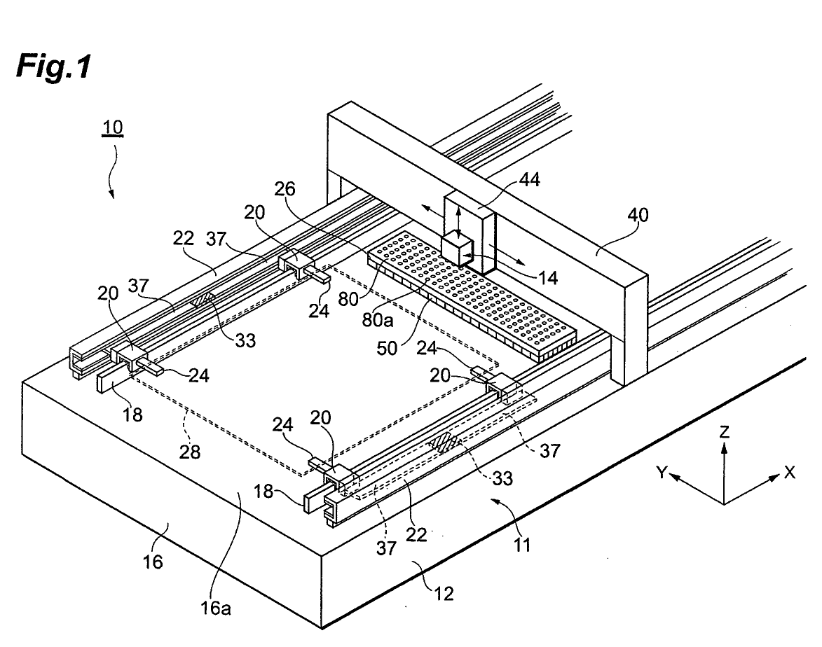

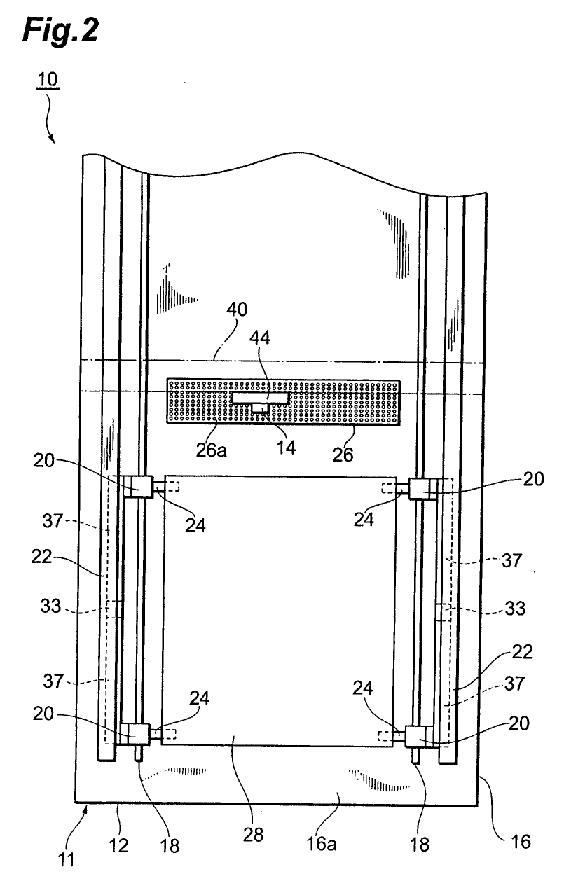

FIG. 1 is a perspective view illustrating construction of a substrate inspection system 10 according to this embodiment. Furthermore, FIG. 2 is a plan view illustrating the construction of this substrate inspection system 10. Incidentally, in FIG. 2, a gantry 40 is indicated with alternate long and short dashed lines.

The substrate inspection system 10 according to this embodiment, as illustrated in FIGS. 1 and 2, comprises a stage apparatus 11 and an inspection device 14. The stage apparatus 11 includes a transport apparatus 12 and a substrate levitation apparatus (transport object levitation apparatus) 26.

The transport apparatus 12 has a base 16, a pair of guide rails 18, four sliders 20, a drive mechanism 22, and four holding members 24.

The base 16 has a rectangular parallelepiped contour, and is placed on a horizontal plane such as a floor. A top face 16a of this base 16 extends in a predetermined direction. The extending direction of the top face 16a of this base 16 is to be a transport direction of a glass substrate (transport object) 28. The width of the base 16 is formed to be rather larger than that of the glass substrate 28. Incidentally, in descriptions hereinafter, as illustrated in FIG. 1, the extending direction of the top face 16a of the base 16 is referred to as a transport direction X, a normal line direction of the top face 16a of the base 16 a vertical direction Z, and the direction orthogonal to both the transport direction X and the vertical direction Z a width direction Y.

A pair of the guide rails 18 is mounted on the top face 16a of the base 16 so as to extend in the transport direction X. A pair of these guide rails 18 is disposed in parallel to each other at an interval rather larger than the width of the glass substrate 28 therebetween.

Sliders 20 are provided two with respect to each of a pair of the guide rails 18. Each slider 20 is guided by the guide rail 18 and provided so as to be capable of moving in the transport direction X. Incidentally, it is preferable to be in a structure in which the width of the glass substrate 28 is larger than that of the base 16, or in which the width of the glass substrate 28 is larger than the interval between a pair of the guide rails 18.

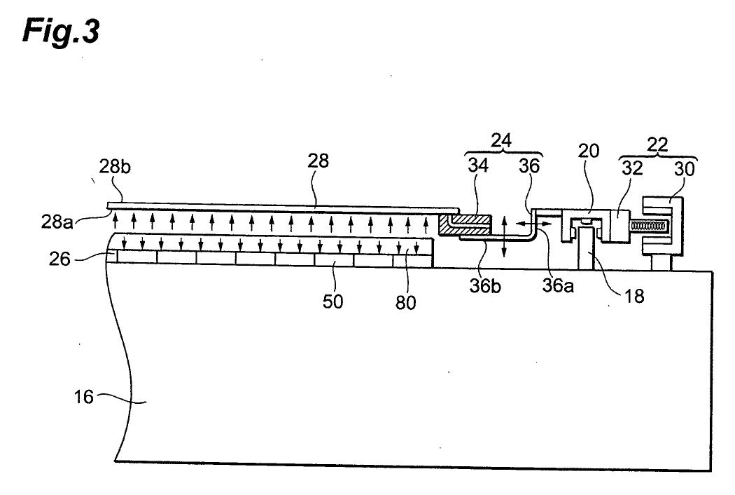

The drive mechanism 22, as illustrated in FIG. 3, is constructed of a linear motor mechanism including a stator 30 and a moving part 32. The stator 30, on the outside of each of a pair of the guide rails 18, is provided on the base 16 so as to be along the guide rail 18. The moving part 32, as illustrated in FIGS. 1 through 3, includes a driven body 33 to be interacted with the stator 30 to be driven, and a connection member 37 that is extended in the transport direction X from both ends of the driven body 33 and provides a connection between the driven body 33 and the slider 20. The connection member 37 is fixed to each outside of the sliders 20. Whereby, two sliders 20 provided at each guide rail 18 are moved in synchronization with a predetermined distance kept.

The holding member 24 is fixed to each inside of four sliders 20. The holding member 24, as illustrated in FIG. 3, includes a suction part 34 and a leaf spring part 36. This holding member 24, by air suction at the suction part 34, sucks and securely holds a side edge of the glass substrate 28. With these holding members 24, the glass substrate 28 is held in a state of being spaced apart from the top face 16a of the base 16. The leaf spring part 36 includes a base portion 36a extending along the vertical direction Z and a bend portion 36b extending along the width direction Y. The suction part 34 is fixed onto the bend portion 36b.

Here, the bend portion 36b of the leaf spring part 36, as illustrated in FIG. 3, preferably possesses a spring property in the vertical direction Z. With the arrangement, the holding member 24 will have a spring property in the vertical direction Z, and thus fine adjustments of a height position of the glass substrate 28 can be made in the vertical direction Z. Whereby, reduced can be a possibility of the occurrence of such a failure as the glass substrate 28 is brought in touch with the substrate levitation apparatus 26.

Furthermore, as to the holding member 24 fixed to two sliders 20 provided at one guide rail 18, the base portion 36a of the leaf spring part 36, as illustrated in FIG. 3, preferably possesses a spring property in the width direction Y. With the arrangement, the holding member 24 will have a spring property in the width direction Y. As a result, when the guide rail 18 is distorted, letting the side of the other guide rail 18 be a reference, the misregistration in the width direction Y of the glass substrate 28 or the rotation of the glass substrate 28 in a plane parallel to the top face 16a of the base 16 can be corrected.

The substrate levitation apparatus 26 is provided in an inspection region on the base 16, as well as under the below-described inspection device 14. This substrate levitation apparatus 26, as illustrated in FIG. 3, blows out and sucks an air to the side of a bottom face 28a of the glass substrate 28.

The length in the width direction Y of the substrate levitation apparatus 26 is provided to be substantially the same as the width of the glass substrate 28. The length in the transport direction X of the substrate levitation apparatus 26 is preferably to be sufficiently long in front of and behind the inspection device 14. As one example, when conveying a glass substrate 28 which length in the transport direction X is 2300 mm, which length in the width direction Y is 2000 mm, and which thickness is 0.6 mm at 250 mm/sec, the length in the transport direction X of the substrate levitation apparatus 26 is to be approximately 400 mm to 500 mm.

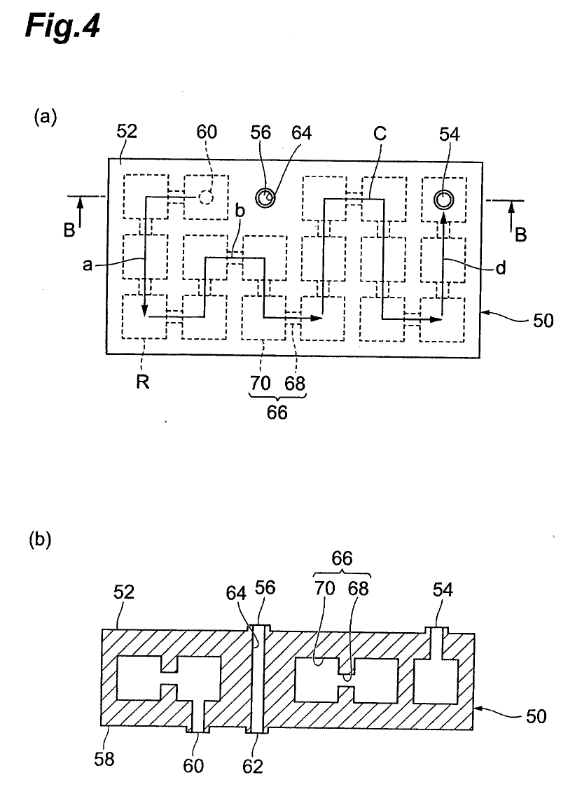

This substrate levitation apparatus 26 includes a plurality of substrate levitation units 50 and a platen 80. FIG. 4 (a) is a plan view of the substrate levitation unit 50, and FIG. 4(b) is a sectional view taken along the line B-B illustrated in FIG. 4(a).

The substrate levitation unit 50, as illustrated in FIG. 4, possesses a substantially rectangular parallelepiped contour, and is formed to be a block of metal such as SUS or resin. The substrate levitation unit 50 is typically dimensioned to be about 15 mm in length, about 30 mm in width, and about 10 mm in thickness. In a top face (one principal surface) 52 of the substrate levitation unit 50, there are provided a blow-out port 54 through which air is blown out, and a suction port 56 through which the air is sucked. Furthermore, in a bottom face (the other principal surface) 58 of the substrate levitation unit 50, there are provided an inlet 60 through which the air is introduced, and an outlet 62 through which the air is drawn out. The suction port 56 and the outlet 62 are provided in positions opposite each other at the top and bottom faces 52 and 58, and are in communication through a suction channel 64. Accordingly, the suction channel 64 is extended in a direction perpendicular to the top and bottom faces 52 and 58.

On the other hand, the inlet 60 and blow-out port 54 are provided in positions spaced apart from each other at the top and bottom faces 52 and 58. Moreover, these inlet 60 and blow-out port 54 are in communication through a blow-out channel 66. This blow-out channel 66 includes a plurality of small channels 68 and a plurality of large channels 70 the channel cross section area of which is larger than that of the small channels 68. In this embodiment, the large channel 70 is constructed to be a space substantially of a cube shape, and the small channel 68 is constructed to be a space substantially of a square shape.

A plurality of the large channels 70 and a plurality of the small channels 68 are disposed alternately in the blow-out channel 66. Whereby, since a channel cross section area discontinuously changes at the boundary between the small channel 68 and the large channel 70, a pressure drop of air can be made to occur at this portion. Furthermore, due to that there are provided a plurality of portions the channel cross section area of which discontinuously changes in such a manner, the pressure drop can be accumulated. The blow-out channel 66 of such construction is extended in a direction along the top face 52 (or the bottom face 58). Owing to that the blow-out channel 66 is extended in a direction along the top face 52 in such a way, the substrate levitation unit 50 can be constructed to be thin while the pressure drop is being accumulated.

In addition, the blow-out channel 66 includes a bend part R that is bent substantially at a right angle, and the large cannel 70 is provided at this bend part R. Whereby, while the large channels 70 and the small channels 68 are being disposed efficiently in a limited space, the pressure drop is accumulated. Incidentally, this blow-out channel 66 runs throughout the unit while being bent at a plurality of the bend parts R, and the portion other than the suction channel 64 is substantially occupied by this blow-out channel 66. Whereby, the pressure drop is sufficiently accumulated in a limited space.

This substrate levitation unit 50 can be formed by, for example, machining an upper part and a lower part individually, and sticking them to each other.

The substrate levitation apparatus 26 includes a plurality of the substrate levitation units 50 of the above-mentioned construction (for example, several hundreds to several thousands), and a plurality of these substrate levitation units 50 is disposed in two-dimensional manner in the state of being in contact with each other such that the top face 52 (and the bottom face 58) is flush.

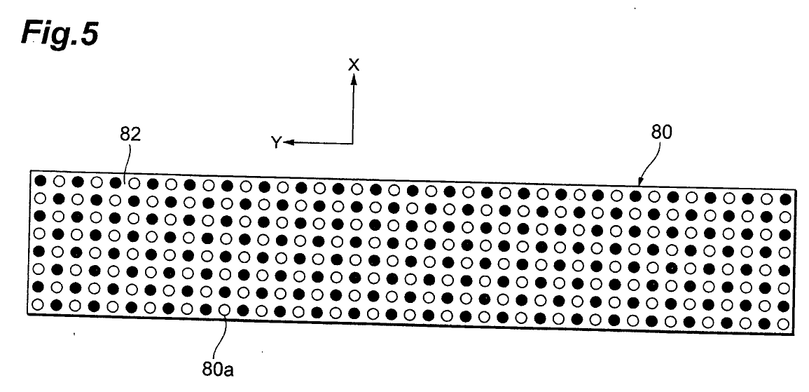

The platen 80, as illustrated in FIG. 5, includes a plurality of through-holes passing air therethrough, and the plurality of through-holes 80a is arrayed at regular intervals in the transport direction X and in the width direction Y. There are provided these through-holes 80a of the same number as the number of the blow-out ports 54 and the suction ports 56 of a plurality of the substrate levitation units 50 arranged two-dimensionally. Incidentally, in FIG. 5, open circles indicate the through-holes 80a for suction, and filled circles indicate the through-holes 80a for blow-out. A top face 82 of the platen 80 is machined with high flatness, and functions as a reference plane with respect to the glass substrate 28.

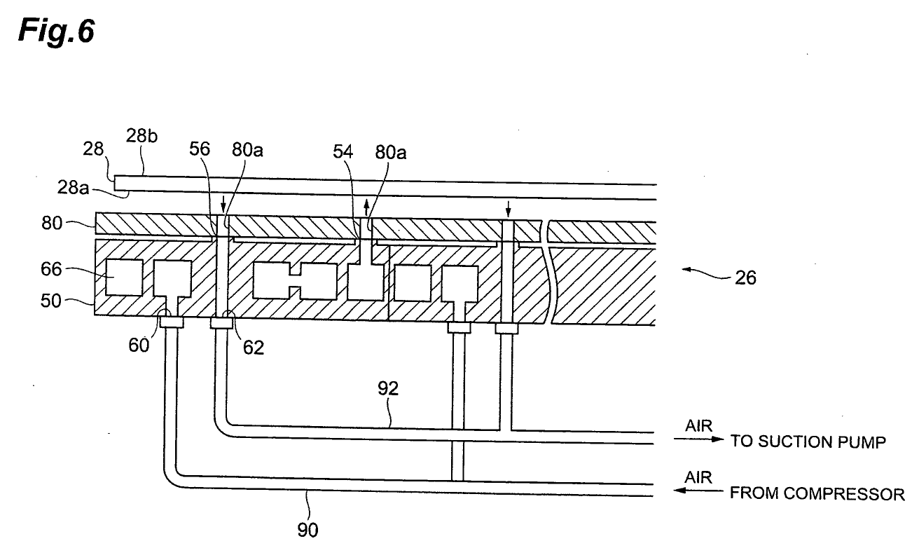

FIG. 6 is a sectional view illustrating a layout relation between the platen 80 and substrate levitation unit 50 of the substrate levitation apparatus 26. As illustrated in FIG. 6, the platen 80 is placed on a plurality of the substrate levitation units 50 arranged two-dimensionally, and a plurality of the through-holes 80a is in communication air-tightly via e.g., a packing with the blow-out ports 54 and the suction ports 56. Incidentally, the inlet 60 that is provided in the bottom face of the substrate levitation unit 50 is connected to a compressor not illustrated via an inlet pipe 90, while the outlet 62 is connected to a suction pump not illustrated via a suction pipe 92. Whereby, air is blown out through the through-holes 80a of the platen 80 from the blow-out ports 54, as well as likewise, the air is sucked from the suction ports 56 through the through-holes 80a of the platen 80, thereby enabling to levitate the glass substrate 26 with a sufficient holding rigidity.

Here, the levitation of the glass substrate 28 by means of the substrate levitation unit 50 will be described in detail with reference to FIGS. 4 and 6.

First, as illustrated in FIG. 6, air from the compressor not illustrated is introduced in the blow-out channel 66 of the substrate levitation unit 50 from the inlet 60 through the inlet pipe 90. The air having been introduced, as illustrated in FIG. 4, flows in order of arrows a to d in the blow-out channel 66, and is blown out from the blow-out port 54. The air having been blown out from the blow-out port 54 (further, from the through hole 80a) is sucked from the suction port 56 (through the through hole 80a) through the gap between the glass substrate 28 and the platen 80. In this flow, in the blow-out channel 66, at the portions the channel cross section area of which discontinuously changes such as “large channel 70 to small channel 68” or “small channel 68 to large channel 70”, the pressure drop occurs. Due to this pressure drop, a holding rigidity when the glass substrate 28 is levitated is increased.

This action will be described with letting a supply pressure of air be constant. When a gap amount h between the glass substrate 28 and the substrate levitation apparatus 26 comes to be larger than that in an equilibrium position, a channel cross section area in the gap is increased, and a flow rate of the air is increased. When letting an amount that is obtained by integrating the pressure in the gap by the area of the glass substrate 28 be W, as the gap amount h is increased, an average pressure in the gap is decreased, and a load capacity W becomes smaller. In this state, since the load capacity W is smaller than that in an equilibrium state, the weight of the glass substrate 28 cannot be supported, and the glass substrate 28 tends to return to the original equilibrium position. Likewise, when the gap amount h becomes smaller, the glass substrate 28 tends to return to the original equilibrium position.

The sensitivity (dW/dh) of this change of the gap amount h providing to the change of the load capacity W corresponds to a holding rigidity of the glass substrate 28. That is, when the load capacity W largely changes due to a little change of the gap amount h (holding rigidity is large), since forces considerably get out of balance, the glass substrate 28 tends to return to the original equilibrium position (gap amount) at once. On the contrary, when this sensitivity is low (holding rigidity is small), since the load capacity W hardly changes even if the gap amount h largely changes, the glass substrate 28 will return to the original equilibrium position slowly. As a result, the air in the gap acts as a virtual spring.

Thus, in this embodiment, the pressure drop is made to occur due to the contraction of area of the combination of the large channels 70 and the small channels 68, and the relation between the pressure in the gap and the flow rate of air is changed, thereby adjusting the relation between the load capacity W and the gap amount h, and achieving a higher spring rigidity. That is, even if the gap amount h is going to increase, since the flow rate of air hardly increases under the influence of the pressure drop owing to the contraction of area, and the load capacity W largely changes, the glass substrate 28 is going to return to the equilibrium position, resulting in a higher holding rigidity. Whereas, even if the gap amount h is going to decrease, since the flow rate of the air hardly decreases under the influence of the pressure drop owing to the contraction of areas, and the load capacity W largely changes, the glass substrate 28 is going to return to the equilibrium position, resulting in a higher holding rigidity.

Incidentally, the design of the blow-out channel 66 of the combination of the large channels 70 and the small channels 68 can be made as follows.

The holding rigidity, as mentioned above, can be calculated in case where the relation between the gap amount h and the load capacity W can be determined. Therefore, first by the calculation of numerical values, parameters of the contraction of area (pressure drop) are changed, and the load capacities W with respect to respective gap amounts h have preliminarily been obtained. Whereby, the parameter of the contraction of area to satisfy the required gap amount and holding rigidity can be obtained. When the parameter of the contraction of area is determined, since the relation between a pressure and a flow rate in this state is determined, the geometric configuration of the blow-out channel 66 is designed by e.g., the computation of fluid flow of numerical values so as to satisfy these characteristics. Based thereon, the substrate levitation unit 50 is formed by molding.

The substrate inspection system 10 will be described again. The inspection device 14 inspects the glass substrate 28 from on the top face 28b side. Examples of the inspection devices 14 include imaging devices such as CCD cameras or laser measuring devices irradiating laser beams and receiving reflected beams thereof. With the imaging device, for example, an optical image such as a circuit pattern formed on the glass substrate 28 can be obtained, thereby enabling the inspection of e.g., defective products. Furthermore, with the laser measuring device, by detecting the reflectance of laser beam, the inspection of e.g., defective products can be made. Incidentally, examples of the inspection devices 14 are not limited to these CCD cameras or laser measuring devices, but include all known devices capable of inspecting the state of the glass substrate 28 contactlessly.

This inspection device 14 is attached to the gantry 40 that is mounted on the base 16 via a slide member 44. The slide member 44 can move in the width direction Y along the gantry 40. Accordingly, the inspection device 14 that is attached to the slide member 44 can move in the width direction Y, and thus scanning in the width direction Y with respect to the glass substrate 28 can be made. Furthermore, the inspection device 14 itself can move in the vertical direction Z with respect to the slide member 44, whereby the inspection device 14 can be supported in a predetermined height position over the base 16. Thus, a focused optical image can be obtained in the imaging device, and the accuracy of data can be improved in the laser measuring device, thus achieving an improved inspection accuracy.

Now, an inspection method of the glass substrate 28 using the above-mentioned substrate inspection system 10 will be described.

First, in a former part of the inspection device 14 over the base 16, with four holding members 24, the glass substrate 28 is sucked and held at the side edges in the width direction Y. At this time, the glass substrate 28 is held in the state of being spaced apart from the top face 16a of the base 16.

Subsequently, by moving the sliders 20 by the drive mechanism 22, the glass substrate 28 is conveyed at a predetermined speed in the transport direction X. Then, when the glass substrate 28 has come to an inspection region, the blow-out and the suction of air is conducted at the bottom face 28a of the glass substrate 28 by means of the substrate levitation apparatus 26. At this time, since the pressure drop of the air is made to occur in the blow-out channel 66, the glass substrate 28 is held with high holding rigidity in a height position of being 50 μm spaced apart from the top face 82 of the platen 80 over the substrate levitation apparatus 26. Incidentally, a levitation amount of the glass substrate 28 is controlled under the pressure of a compressor, not illustrated, that is connected to the inlet 60 of the substrate levitation unit 50 via the inlet pipe 90.

Subsequently, as mentioned above, at the same time as the blow-out and the suction of air with respect to the bottom face 28a of the glass substrate 28 is conducted in the inspection region, the conveyance of the glass substrate 28 in the transport direction X is stopped. Then, the slide member 44 is made to slide in the width direction Y, and thus scanning is made on the glass substrate 28 by means of the inspection device 14. At this time, as needed, preferably fine adjustments of the position in the vertical direction of the inspection device 14 may be made. When scanning is ended, the glass substrate 28 is made to move a predetermined distance in the transport direction X; and after the conveyance thereof has been stopped again, the second scanning is made. By making plural times of scanning in such a manner, the glass substrate 28 is inspected from the top face 28b by means of the inspection device 14. At this time, since the holding rigidity of the glass substrate 28 is made higher, vibration is suppressed, and thus an inspection accuracy of the glass substrate 28 is improved.

Next, with respect to the glass substrate 28 having been inspected already that has passed through the inspection region and has been conveyed to a latter part of the base 16, the suction by means of the holding members 24 is stopped. Then, the glass substrate 28 is conveyed to the outside of the system, as well as for inspection with respect to the next glass substrate 28, the holding members 24 are returned to the former part of the base 16.

As described in detail heretofore, in this embodiment, since when the blow-out and the suction of air is conducted with respect to the glass substrate 28 using the substrate levitation apparatus 26, the pressure drop can be made to occur in the blow-out channel 66, the holding rigidity of the glass substrate 28 can be made higher. As a result, the vibration of the glass substrate 28 can be suppressed in the inspection region using the inspection device 14, and thus inspection accuracy can be improved.

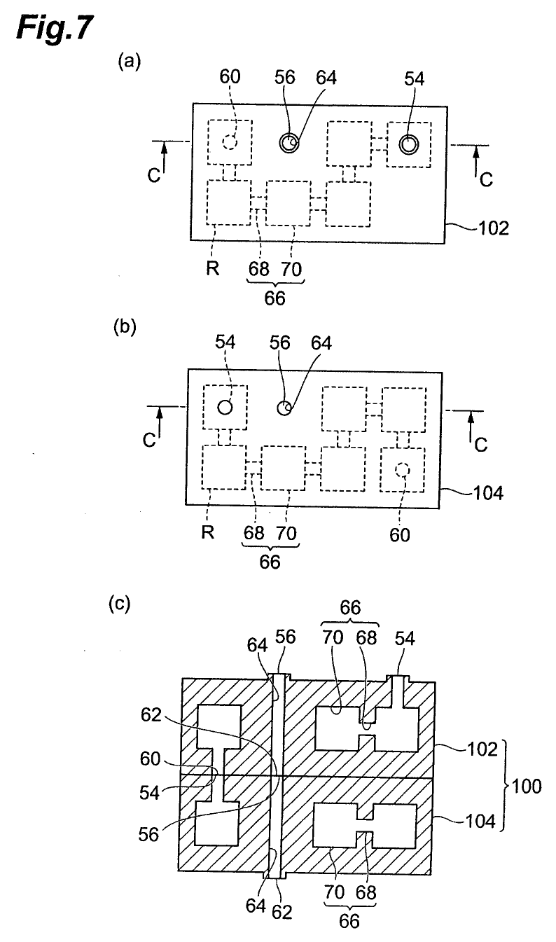

Incidentally, the present invention is not limited to the above-mentioned embodiment, but can be variously modified. For example, as illustrated in FIG. 7, a substrate levitation unit 100 may be constructed to be a laminate of units 102 and 104 in a direction perpendicular to the top and bottom faces. FIG. 7(a) is a plan view of a substrate levitation unit 102 of a second tier according to a variation: FIG. 7(b) is a plan view of a substrate levitation unit 104 of a first tier according to the variation; and FIG. 7(c) is a sectional view (in a state that both units are laminated) taken along the line C-C illustrated in FIGS. 7(a) and 7(b).

Each of the substrate levitation units 102 and 104, as illustrated in FIG. 7, possesses a substantially rectangular parallelepiped contour. At the top face of the substrate levitation unit 102, 104, there are provided a blow-out port 54 through which air is blown out, and a suction port 56 through which the air is sucked. In addition, at the bottom face of the substrate levitation unit 102, 104, there are provided an inlet 60 through which air is introduced, and an outlet 62 through which the air is drawn out. The suction port 56 and the outlet 62 are provided in positions facing each other at the top and bottom faces, and are brought in communication through the suction channel 64. Thus, the suction channel 64 is extended in a direction perpendicular to the top and bottom faces.

Whereas, the inlet 60 and the blow-out port 54 are provided in positions spaced apart from each other at the top and bottom faces. Further, these inlet 60 and blow-out port 54 are brought in communication through the blow-out channel 66. This blow-out channel 66 includes a plurality of small channels 68 and a plurality of large channels 70 which channel cross section area is larger than that of the small channel 68. Moreover, the blow-out channel 66 includes a bend part R that is bent substantially at a right angle, and at this bend part R, there is provided the large channel 70.

Here, the suction port 56 of the substrate levitation unit 104 of the first tier is provided in a position corresponding to the outlet 62 of the substrate levitation unit 102 of the second tier; and the blow-out port 54 of the substrate levitation unit 104 of the first tier is provided in a position corresponding to the inlet 60 of the substrate levitation unit 102 of the second tier.

Then, due to that the second tier of the substrate levitation unit 102 is laminated on the first tier of the substrate levitation unit 104, the suction channels 64 are connected to each other air-tightly, and further the blow-out channels 66 are connected to each other air-tightly.

When using the substrate levitation unit 100 of such a laminate type, since the blow-out channel 66 can be made longer in a limited installation space, a sufficient pressure drop can be accumulated.

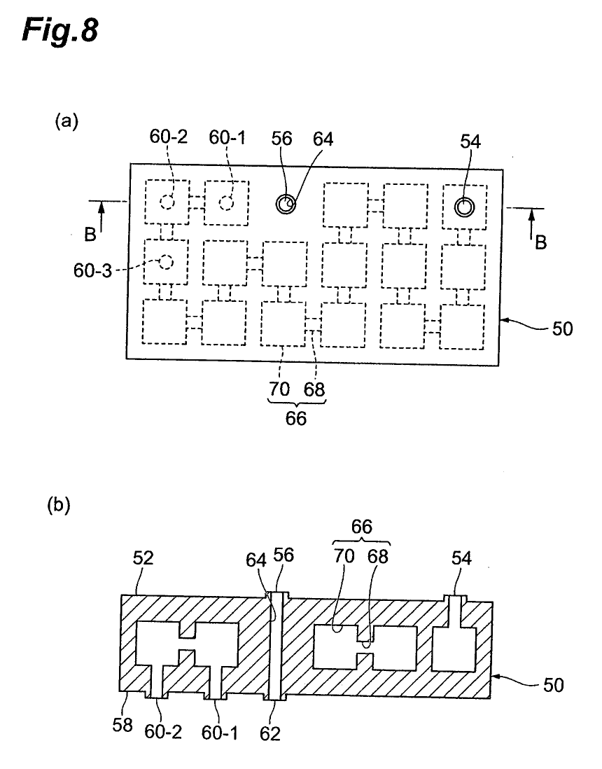

Furthermore, in the substrate levitation unit 50 according to the above-mentioned embodiment, as illustrated in FIG. 8, there is provided at the bottom face 58 a plurality of inlets 60 through which air is introduced, and the plurality of inlets 60-1 to 60-3 may be communicated with the blow-out channel 66 at different positions. Here, FIG. 8(a) is a plan view of the substrate levitation unit 50 according to a variation, and FIG. 8(b) is a sectional view taken along the line B-B illustrated in FIG. 8(a). With the arrangement, for example, in the case where one inlet 60-2 is selected, and the other inlets 60-1 and 60-3 are closed, the length of the blow-out channel 66 can be adjusted to be shorter than that in the case described in FIG. 4. As a result, fine adjustments of the pressure drop can be made.

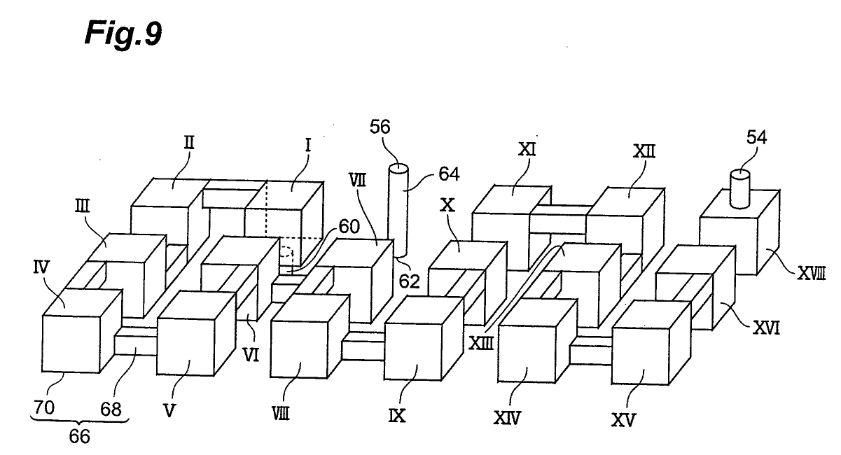

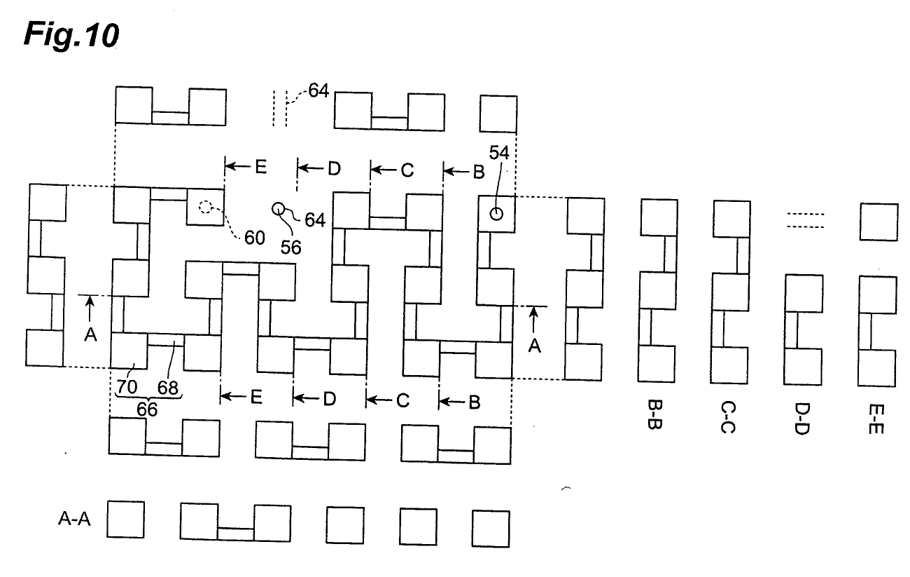

Moreover, in the substrate levitation unit 50 according to the above-mentioned embodiment, the blow-out channel 66 may be constructed as follows. FIG. 9 is a perspective view of extracting and illustrating only the blow-out channel 66 and the suction channel 64 from the substrate levitation unit 50. Furthermore, FIG. 10 includes a plan view and a side view of extracting and illustrating only the blow-out channel 66 and the suction channel 64, and views indicated by arrows taken along the lines A-A to E-E.

As illustrated in FIGS. 9 and 10, the blow-out channel 66 is constructed of alternately disposed large channels 70 and small channels 68. Thus, to the large channel 70 which inner wall surface is cubic or cuboid, an entry side and an exit side of the small channel 68 are connected. There are roughly three patterns of connection forms of the large channel 70 and the small channel 68, and these three patterns of connection forms are properly used in place.

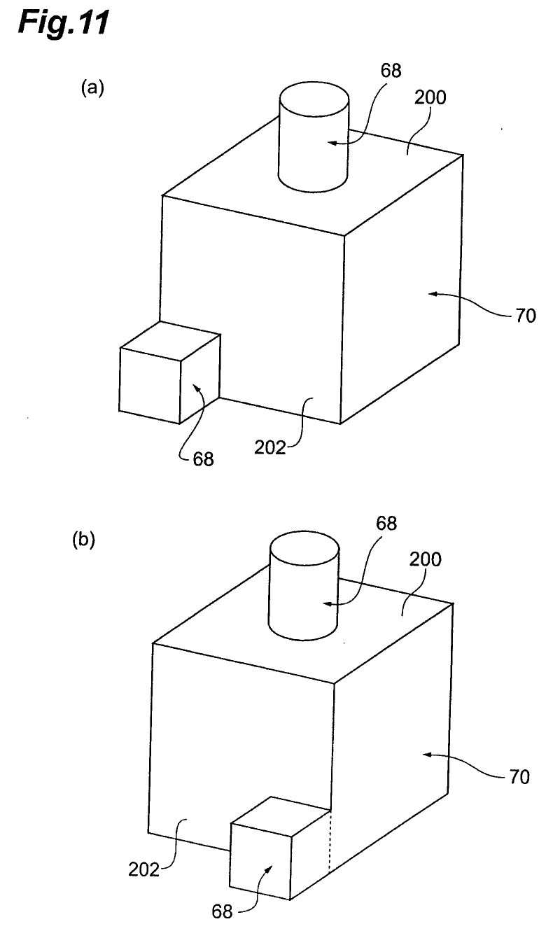

That is, as illustrated in FIG. 11, as one form, the small channel 68 on the entry side of the large channel 70 and the small channel 68 on the exit side of the large channel 70 are connected to inner wall surfaces 200 and 202 adjacent to each other of the large channel 70 respectively. Furthermore, one of the small channels 68 on the entry side and the exit side of the large channel 70 is connected to a central portion of the inner wall surface 200, and the other of the small channels 68 is connected to a corner portion of the inner wall surface 202 in the position most remote from the connection position of the above-mentioned one of small channels 68. The small channel 68 is rectangular or circular in a cross section, and a channel cross section area thereof is approximately 1/16 to ¼ the channel cross section area of the large channel 70, preferably approximately 1/9. Incidentally, FIGS. 11(a) and 11(b) illustrate cases in which the small channels 68 are connected to different corner portions. In the blow-out channel 66 illustrated in FIGS. 9 and 10, the connection form of FIG. 11(b) is applied to the large channel 70 indicated by I, and the connection form of FIG. 11(a) is applied to the large channel 70 indicated by XVII.

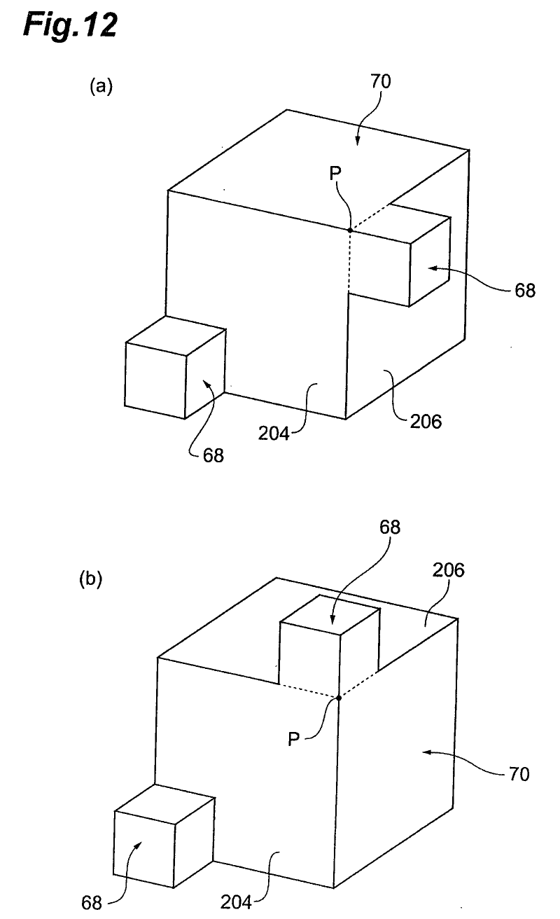

Moreover, as illustrated in FIG. 12, as one form, the small channel 68 on the entry side of the large channel 70 and the small channel 68 on the exit side of the large channel 68 are connected to inner wall surfaces 204 and 206 adjacent to each other of the large channel 70 respectively. One of the small channels 68 on the entry side and the exit side of the large channel 70 is connected to one corner portion of the inner wall surface 204, and the other of the small channels 68 is connected to one corner portion of the inner wall surface 206 that forms one apex P together with a corner portion positioned on a diagonal line of the above-mentioned one corner portion on the inner wall surface 204. The small channel 68 is rectangular or cuboid in a cross section, and a channel cross section area thereof is approximately 1/16 to ¼ the channel cross section area of the large channel 70, preferably approximately 1/9. Incidentally, FIGS. 12(a) and 12(b) illustrate cases in which the small channels 68 are connected to different corner portions. In the blow-out channel 66 illustrated in FIGS. 9 and 10, the connection form of FIG. 12(a) is applied to the large channel 70 indicated by II, IV, VII, VIII, XI, and XIV, and the connection form of FIG. 12(b) is applied to the large channel 70 indicated by V, VI, IX, XII, and XV.

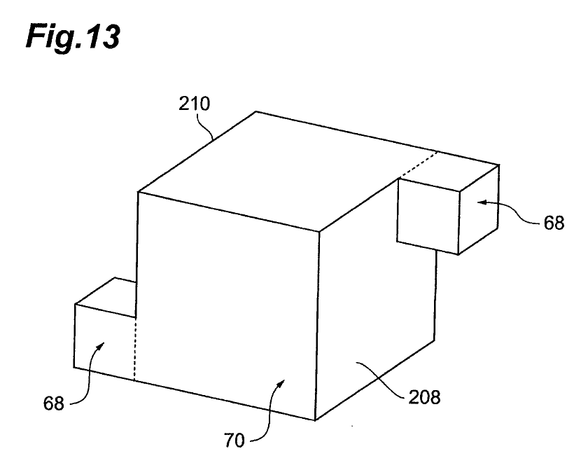

Furthermore, as illustrated in FIG. 13, as one form, the small channel 68 on the entry side of the large channel 70 and the small channel 68 on the exit side of the large channel 70 are connected to inner wall surfaces 208 and 210 opposed to each other of the large channel 70 respectively. In addition, the small channel 68 on the entry side is connected to one corner portion of the inner wall surface 68, and the small channel 68 on the exit side is connected to one corner portion of the inner wall surface 210 in the position most remote from the above-mentioned one corner portion. The small channel 68 is rectangular or circular in a cross section, and a channel cross section area thereof is approximately 1/16 to ¼ the channel cross section area of the large channel 70, preferably approximately 1/9. In the blow-out channel 66 illustrated in FIGS. 9 and 10, the connection form of FIG. 13 is applied to the large channel 70 indicated by III, X, XIII, and XVI.

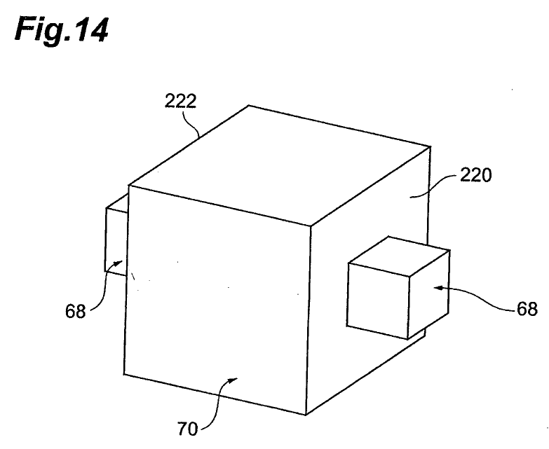

According to the connection forms illustrated in FIGS. 11 to 13, a larger pressure drop can be accumulated, and thus the substrate levitation unit 50 can be made compact. Incidentally, FIG. 14, as a comparative example, illustrates a connection form in which the entry side and exit side of small channels 68 are connected to the central portions of inner wall surfaces 220 and 222 opposed to each other of the large channel 70 respectively. In actual, by the measurement of the pressure drop to be obtained in the connection forms illustrated in FIGS. 11 to 13, and the pressure drop to be obtained in the connection form illustrated in FIG. 14, in the connection forms illustrated in FIGS. 11 to 13, the pressure drop of about five times the value to be obtained in the connection form illustrated in FIG. 14 is confirmed to be capable of being obtained.

Moreover, although in the above-mentioned embodiment, a plurality of the substrate levitation units 50 is disposed two-dimensionally, and the platen 80 is placed thereon to form the substrate levitation apparatus 26, a plurality of the substrate levitation units 50 may be constructed not to be unitized, but to be an integral whole extended two-dimensionally. In this case, the part corresponding to one unit will be the substrate levitation unit 50. However, in case of being unitized as the substrate levitation unit 50, the apparatus can be applied, flexibly meeting the needs of various sizes of transport objects, thus to be desired.

Furthermore, although the above-mentioned substrate inspection system 10 is constructed such that the inspection device 14 is slid in the width direction Y by means of the slide member 44 to scan the glass substrate 28, it is preferable to use an inspection device array in which the inspection devices 14 are aligned in an array in the width direction Y to construct a substrate inspection system. With the arrangement, the glass substrate 28 needs not to be scanned in the width direction Y, thus achieving improvement in inspection efficiency.

Furthermore, although in the above-mentioned embodiment, an example in which the stage apparatus 11 including the substrate levitation apparatus 26 is applied to the substrate inspection system 10 is described, the present invention may be applied to an application system in which a photo-resist liquid or an application liquid such as ink when forming a laminate of a color filter is applied onto the top face 28b of the glass substrate 28. Also in such an application system, since the holding rigidity of the glass substrate 28 is high, and vibration can be suppressed, the application liquid can be uniformly applied.

Moreover, although in the above-mentioned embodiment, the conveyance of the glass substrate 28 as a transport object is described, the transport object may be other members such as films or semiconductor substrates.

Furthermore, the present invention is applicable, for example, to other systems such as PDP manufacturing apparatuses manufacturing plasma display panels (PDP), or semiconductor inspection devices inspecting e.g., defects of a semiconductor substrate.

What is claimed is:

1. A transport object levitation unit comprising: a blow-out channel configured to blow out an air from a blow-out port provided on one principal surface side; and a suction channel configured to suck an air from a suction port provided on the one principal surface side,
wherein the blow-out channel includes a portion the channel cross section area of which discontinuously changes.

2. The transport object levitation unit according to claim 1, wherein the blow-out channel includes a small channel and a large channel the channel cross section area of which is larger than that of the small channel.

3. The transport object levitation unit according to claim 2, wherein the blow-out channel is constructed of a plurality of the small channels and a plurality of the large channels being alternately disposed.

4. The transport object levitation unit according to claim 3, wherein the blow-out channel is extended in a direction along the one principal surface.

5. The transport object levitation unit according to claim 4, wherein the blow-out channel includes a bend part that is bent substantially at a right angle, and the large channel is provided at the bend part.

6. The transport object levitation unit according to claim 3, wherein the suction channel is extended along a direction substantially orthogonal to the one principal surface, and the portion other than the suction channel is substantially occupied by the blow-out channel.

7. The transport object levitation unit according to claim 3, wherein:
a plurality of inlets for introducing an air in the blow-out channel is provided on the other principal surface side facing the one principal surface; and
a plurality of the inlets is communicated with the blow-out channel at different positions.

8. The transport object levitation unit according to claim 3, wherein: at least one of the plurality of large channels is constructed to be cubic or cuboid at an inner wall surface thereof, and the small channel on an entry side of the large channel and the small channel on an exit side of the large channel are connected to a first and a second inner wall surfaces facing each other of the large channel respectively; and
the small channel on the entry side of the large channel is connected to one corner portion of the first inner wall surface, and the small channel on the exit side of the large channel is connected to one corner portion of the second inner wall surface at a position most remote from the one corner portion to which the small channel on the entry side of the large channel is connected.

9. The transport object levitation unit according to claim 3, wherein: at least one of the plurality of large channels is constructed to be cubic or cuboid at an inner wall surface thereof, and the small channel on an entry side of the large channel and the small channel on an exit side of the large channel are connected to a first and a second inner wall surfaces adjacent to each other of the large channel respectively; and
one of the small channels on the entry side and the exit side of the large channel is connected to one corner portion of the first inner wall surface, and the other of the small channels different from the one of the small channels is connected to one corner portion on the second inner wall surface that forms one apex together with a corner portion positioned on a diagonal line of the one corner portion on the first inner wall surface.

10. The transport object levitation unit according to claim 3, wherein: at least one of the plurality of large channels is constructed to be cubic or cuboid at an inner wall surface thereof, and the small channel on an entry side of the large channel and the small channel on an exit side of the large channel are connected to a first and a second inner wall surfaces adjacent to each other of the large channel respectively; and
one of the small channels on the entry side and the exit side of the large channel is connected to a central portion on the first inner wall surface, and the other of the small channels different from the one of the small channels is connected to a corner portion on the second inner wall surface in a position most remote from the connection position of the one small channel.

11. The transport object levitation apparatus comprising a plurality of the transport object levitation units according to claim 1,
wherein the plurality of the transport object levitation units are laminated in a direction perpendicular to the one principal surface.

12. A transport object levitation apparatus comprising a plurality of the transport object levitation units according to claim 1,
wherein the plurality of the transport object levitation units are disposed two-dimensionally in a direction along the one principal surface.

13. The transport object levitation apparatus according to claim 12, further comprising a platen including a plurality of through-holes,
wherein the platen is placed on the one principal surface of the plurality of the transport object levitation units disposed two-dimensionally, and the plurality of through-holes are communicated air-tightly with the blow-out port and the suction port.

14. A stage apparatus comprising:
the transport object levitation apparatus according to claim 12; and
a transport apparatus configured to grip a transport object and cause it to pass over the transport object levitation apparatus.

15. The transport object levitation unit according to claim 1, wherein:
the unit has a substantially rectangular parallelepiped contour and is formed to be a block, and
the blow-out channel and the suction channel are formed in the block.

16. A transport object levitation unit comprising:
a solid body having a first and a second principal surfaces opposed each other;
a blow-out channel provided in the solid body and communicated with a blow-out port provided on the first principal surface; and
a suction channel provided in the solid body and communicated with a suction port provided on the first principal surface,
wherein the blow-out channel includes a portion the channel cross section area of which discontinuously changes.

17. The transport object levitation unit according to claim 16, further comprising:
an inlet provided on the second principal surface and communicated with the blow-out channel through which the air is introduced; and
an outlet provided on the second principal surface and communicated with the suction channel through which the air is drawn out.

18. The transport object levitation unit according to claim 16, wherein the solid body has a substantially rectangular parallelepiped contour.
